(19) United States
(12) Patent Application Publication
(10) Pub. No.: US 2026/0266440 A1
(43) Pub. Date: Sep. 10, 2026

(54) COMPACT ADJUSTABLE DOWNLIGHT FIXTURE

(71) Applicant: SIGNIFY HOLDING B.V., EINDHOVEN (NL)

(72) Inventor: SUDEV GEETHA SURENDRAN, KOZHIKODE (IN)

(21) Appl. No.: 19/166,069

(22) PCT Filed: Mar. 13, 2024
(86) PCT No.: PCT/EP2024/056654

§ 371 Date: Sep. 17, 2025

(30) Foreign Application Priority Data
Mar. 17, 2023 (IN) 20234108184
Jun. 13, 2023 (EP) 23178980.1

(51) Int. Cl. F21S 8/02; F21V 5/04; F21V 7/04; F21V 21/26; F21V 21/30; F21V 29/76; F21V 31/00; F21Y 115/10

(52) U.S. Cl. CPC F21S 8/026; F21V 5/04; F21V 7/041; F21V 21/26; F21V 21/30; F21V 29/763; F21V 31/005; F21Y 2115/10

(57) ABSTRACT

The present invention relates to an adjustable downlight fixture (1), comprising: an enclosure (2) for accommodating LED optics (3), the enclosure (2) having an arc-shaped roof (4) having an inner surface (5) and an outer surface (6), the arc-shaped roof (4) further comprising an opening (7); at least one pivot arm (8) for connecting the LED optics (3) to the enclosure (2), the pivot arm (8) having a first and a second end (9, 10), the first end (9) being pivotally connected to the enclosure (2) at a rotation axis (X) and the second end (10) being arranged to be connected to the LED optics (3); and a heat sink (12) having an arc-shaped base surface (13) arranged adjacent to the outer surface (6) of the arc-shaped roof (4) of the enclosure (2), wherein the curvature of the base surface (13) is substantially the same as the curvature of the arc-shaped roof (4); wherein the heat sink (12) is arranged to be connected to the LED optics (3) by a connector shaft (14) extending through the opening (7) in the arc-shaped roof (4); and wherein the area of the base surface (13) of the heat sink (12) is greater than the area of the opening (7) such that the arc-shaped base surface (13) covers the opening (7) for enabling air-tight enclosure (2).

### FIELD OF THE INVENTION

The invention relates to an adjustable downlight fixture having a dustproof and air-tight enclosure.

### BACKGROUND OF THE INVENTION

An adjustable downlight is a recessed ceiling light that can be tilted and/or rotated to illuminate areas of interest. Such adjustable downlights are widely used by lighting designers who wish to create a certain light setting in a room. Adjustable downlight fixtures need to be air-tight in order to ensure energy saving of the air conditioning in the room. An open downlight fixture would cause the conditioned air to leak to the plenum, wherein the air would be heated and mix with the conditioned air in the room, thus raising the overall temperature in the room and causing unnecessary stress on the air conditioning system. Another benefit of having an air-tight downlight fixture is that it can protect the internal components like the LED optics from the dust and debris above the ceiling. Currently, adjustable downlight fixtures are installed inside a fixture housing to achieve air-tight compliance.

However, this approach suffers from multiple disadvantages. In particular, the fixture housing can't be installed through a ceiling hole; the fixture housing needs to be installed in the ceiling frames before fixing the ceiling, thus preventing retrofitting. Further, the fixture housing constitutes an added cost. Finally, the solutions of the prior art provide inefficient heat dissipation since the fixture heat sink is enclosed within the fixture housing.

Another way to obtain an air-tight enclosure is to provide an air-tight part, e.g. a lens, between the optics and the trim. Such a solution suffers from the disadvantage of impaired optical characteristics and performance due to lens interference (e.g. part of the light gets cut off/reflected). Further, such an adjustable downlight fixture still needs to be placed inside a fixture housing to protect the components from dust and debris accumulation, thus introducing the problems associated with the fixture housing approach mentioned above. Consequently, there is an increased need for a compact downlight fixture that is easy to mount from below the ceiling of the room, that offers an appropriate amount of lighting in the required area, and that is air-tight and dustproof.

### SUMMARY OF THE INVENTION

The present invention thus eliminate shortcomings of the prior art. To this end, the present invention provides an adjustable downlight fixture, comprising an enclosure for accommodating LED optics, the enclosure having an arc-shaped roof having an inner surface and an outer surface. The inner surface of the roof is arranged to face the LED optics, while the outer surface is arranged to face away from the LED optics.

By the term “arc-shaped” is in the context of the present invention understood a continuous portion of a curved line describing a circle or ellipse. The term “roof” is in the context of the present invention supposed to mean the portion of the enclosure being arranged at a distance from the light exit window.

The arc-shaped roof of the enclosure further comprises an opening. The size and shape of the opening may vary depending on the desired need and design. In particular, the opening may be substantially circular or elliptical. The ratio between the area of the opening and the area of the arc-shaped roof may be from 0.01 to 0.5.

The shape of the enclosure may be determined by checking whether it can accommodate the tilting LED optics from 0 degrees to the required tilt angle. In particular, the enclosure may have a bent cylindrical shape. Such an embodiment offers the advantage of desirable tilting and/or rotation of the LED optics within the enclosure. Alternatively, the enclosure may have a simple cylindric form with an arc-shaped roof for smaller LED optics.

The adjustable downlight fixture of the present invention further comprises at least one pivot arm for connecting the LED optics to the enclosure. The pivot arm has a first and a second end, the first end being pivotally connected to the enclosure at a rotation axis and the second end being arranged to be connected to the LED optics. Preferably, the LED optics is connected to the enclosure by two pivot arms. The LED optics is arranged to rotate relative the rotation axis to achieve the angle adjustment. The rotation of the LED optics is based on the rotation axis where the pivot arms are connected. This rotation axis is determined by considering the different required tilt positions of LED optics. The construction of the rest of the components depends on this selected rotation axis.

The LED optics may comprise a mount plate arranged to be connected to the at least one pivot arm. In particular, two pivot arms may be connected to the LED optics mount plate. Both pivot arms are arranged inside the enclosure. Such an embodiment ensures a clean and unobtrusive look of the downlight fixture from the outside and ensures that the mechanism is protected from the dust and debris from the external ceiling area.

The at least one pivot arm may comprise a tilt-locking element. Such an element may be in the form of a slot and a fastening element, e.g. a screw, extending through the slot. When the fastening element is fixated inside the slot, tilting of the LED optics will be prevented. The tilt-locking element should be accessible from the outside of the enclosure in order to be readily operatable by the user.

The roof of the enclosure is shaped like an arc with the selected rotation axis as the center.

The adjustable downlight fixture of the present invention further comprises a heat sink having an arc-shaped base surface arranged adjacent to the outer surface of the arc-shaped roof of the enclosure, wherein the curvature of the base surface is substantially the same as the curvature of the arc-shaped roof. The heat sink is arranged to be connected to the LED optics by a connector shaft extending through the opening in the arc-shaped roof.

Importantly, the area of the arc-shaped base surface of the heat sink is greater than the area of the opening in the arc-shaped roof of the enclosure, such that the arc-shaped base surface covers the opening for enabling air-tight enclosure.

The area of the arc-shaped roof of the enclosure may be equal to the area of the base surface of the heat sink. Such an embodiment offers the advantage of an improved aesthetical appearance and compact design, while ensuring that the opening in the arc-shaped roof is covered by the base surface of the heat sink at all times.

When the LED optics is rotated to adjust the angle, the connected heat sink also rotates along with it. The heat sink base maintains a sliding contact with the arc-shaped roof of the enclosure since both the curvatures are matching. The opening in the arc-shaped roof of the enclosure is the only opening in the enclosure. The opening gets completely covered by the base surface of the heat sink resting on the outer surface of the arc-shaped roof of the enclosure in all the tilted states. This ensures an air-tight and dustproof downlight fixture.

The heat sink has an arc-shaped base surface with the selected rotation axis as the center. The heat sink is designed to rest on the arc-shaped roof of the enclosure. The connector shaft may be extruded and may be arranged at the center of the base surface. The connector shaft and the heat sink may be extruded as a single piece.

The connector shaft passes through the opening in the arc-shaped roof of the enclosure and is connected to the LED optics inside the enclosure. As mentioned above, the base surface of the heat sink resting on the arc-shaped roof of the enclosure covers the opening in all tilting positions. The LED optics is completely within the enclosure and only the heat sink is external to the enclosure. This ensures protection of LED optics from external dust and debris and provides improved and unobstructed optical performance. The external heat sink connected through the connector shaft ensures good heat dissipation.

The heat sink can be aligned with the enclosure to get a compact form while installing the downlight fixture. This ensures a simple installation from below the ceiling. The user can tilt and/or rotate the LED optics thus adjusting the angle of lighting by accessing from below the trim. As already have been mentioned, the base surface of the heat sink covers the opening in the arc-shaped roof of the enclosure to ensure a sealed housing from 0-degree to maximum tilt and in all the intermediate tilt positions.

In order to further improve heat dissipation, the heat sink may comprise a plurality of baffles arranged on the surface being opposite to the base surface. Alternatively or additionally, the heat sink may comprise thermally conductive material, e.g. copper, silver or aluminum.

The adjustable downlight fixture according to the present invention doesn't require additional fixture housing in order to fulfill air-tightness and dustproof requirements. The heat sink of the adjustable downlight fixture of the present invention covers the opening in the enclosure at all inclination angles to ensure an air-tight and dustproof fixture. This approach overcomes the disadvantages associated with using additional fixture housing. Further, the downlight fixture of the present invention ensures good optical performance because the light is not getting obstructed/cut off by parts below the optics.

The invention utilizes the heat sink design to cover the only opening in the enclosure roof in order to provide an airtight housing of the adjustable downlight fixture. This ensures an air-tight and dustproof enclosure in all the different adjustable angles of the LED optics. This approach eliminates the need for using an additional fixture housing to fulfil the airtightness requirements. The downlight fixture of the present invention is compact, and hence can be easily installed from below the ceiling, thus enabling retrofitting. The downlight fixture of the present invention ensures that the LED optics is completely within the enclosure in order to protect it from external dust and debris. The downlight fixture of the present invention also ensures the best optical characteristics/performance since the optics is not getting cut off/interfered with other parts below it. Finally, the heat sink is external to the fixture enclosure, which ensures good heat dissipation.

According to the present invention, the fixture may further comprise a reflector arranged downstream from the LED optics. The term “downstream” is in the context of the present invention intended to mean being arranged in a succeeding manner in the direction of the light emitted by the lighting device comprising the downlight fixture according to the present invention. The reflector may be in the form of a detachable part connected to the bottom of the enclosure. The bottom of the enclosure may coincide with the light exit window.

The downlight fixture may further comprise a mount ring arranged downstream from the LED optics. Such an embodiment offers the advantage of an improved aesthetical appearance and more secure attachment of the downlight fixture to the ceiling.

The LED optics may comprise at least one LED light source. Alternatively or additionally, the LED optics may comprise at least one lens.

In the context of the present invention, the term “downlight” is to be understood as a direction of light aligned with a vector of gravitational acceleration. The vector of gravitational acceleration may be understood as being a gravitational acceleration vector of a celestial body, e.g. the Earth, on which the downlight fixture is arranged or located.

Each of the LED light sources may emit light having a dominant peak wavelength in a wavelength range being different from the wavelength ranges of the light emitted by the other LED light sources, thus providing a possibility to obtain different spectra and thus different CCTs in the different beams of the device light. Another advantage of such an embodiment is a possibility to enable a horizontal light distribution with a higher MDER (Human Centric Light effect) and functional lighting with e.g. 4000K.

Each LED light source may be pixelated in order to allow CCT tuning, e.g. 3000K, 4000K, 5000K and 6500K, depending on the application and/or time of the day (follow daylight curve).

### BRIEF DESCRIPTION OF THE DRAWINGS

This and other aspects of the present invention will now be described in more detail, with reference to the appended drawings showing embodiment(s) of the invention.

FIG. 1 shows a side view of an adjustable downlight fixture according to the present invention;

FIG. 2 shows a cross-sectional view of the adjustable downlight fixture shown in FIG. 1;

FIG. 3 depicts another side view of the adjustable downlight fixture shown in FIG. 1;

FIG. 4 illustrates cross-sectional view of the fixture in downlight position (zero degree tilt at this position);

FIGS. 5-7 show different tilt positions of the adjustable downlight fixture—FIG. 6 is zero degree tilt, FIG. 7 is maximum tilt, FIG. 5 is intermediate tilt;

FIGS. 8-10 illustrate another embodiment of the adjustable downlight fixture of the present invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

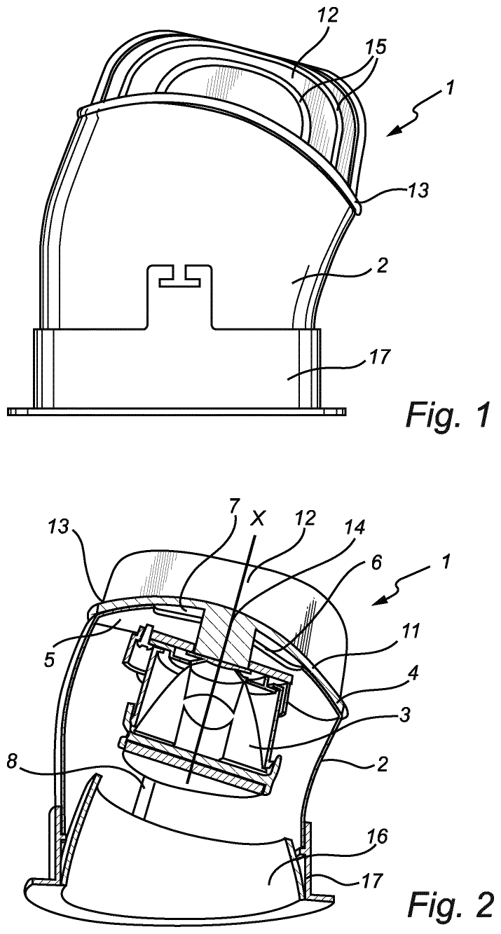

FIGS. 1 and 2 depict a side view and a cross-sectional view of the cross-sectional view, respectively, of the adjustable downlight fixture 1 according to the present invention. The adjustable downlight fixture 1 comprises an enclosure 2 for accommodating LED optics 3. The enclosure 2 has an arc-shaped roof 4 having an inner surface 5 and an outer surface 6. The inner surface 5 of the roof is arranged to face the LED optics 3, while the outer surface 6 is arranged to face away from the LED optics 3.

The arc-shaped roof 4 of the enclosure 2 further comprises an opening 7. The opening 7 is substantially circular.

As may be seen in FIGS. 1 and 2, the enclosure 2 has a bent cylindrical shape. Such an embodiment offers the advantage of desirable tilting and/or rotation of the LED optics 3 within the enclosure 2.

The adjustable downlight fixture 1 further comprises two pivot arms 8 for connecting the LED optics 3 to the enclosure 2. The pivot arms 8 have a first and a second end 9, 10, the first end 9 being pivotally connected to the enclosure 2 at a rotation axis X and the second end 10 being arranged to be connected to the LED optics 3. The LED optics 3 is arranged to rotate relative the rotation axis X to achieve the angle adjustment. The rotation of the LED optics 3 is based on the rotation axis X where the pivot arms 8 are connected. This rotation axis X is determined by considering the different required tilt positions of LED optics 3. The construction of the rest of the components depends on this selected rotation axis X.

The LED optics 3 comprises a mount plate 11 arranged to be connected to the pivot arms 8. Both pivot arms 8 are arranged inside the enclosure 2. Such an embodiment ensures a clean and unobtrusive look of the downlight fixture 2 from the outside and ensures that the mechanism is protected from the dust and debris from the external ceiling area.

The roof 4 of the enclosure 2 is shaped like an arc with the selected rotation axis X as the center.

The adjustable downlight fixture 1 of the present invention further comprises a heat sink 12 having an arc-shaped base surface 13 arranged adjacent to the outer surface 6 of the arc-shaped roof 4 of the enclosure 2, wherein the curvature of the base surface 13 is substantially the same as the curvature of the arc-shaped roof 4. The heat sink 12 is arranged to be connected to the LED optics 3 by a connector shaft 14 extending through the opening 7 in the arc-shaped roof 4.

Importantly, the area of the arc-shaped base surface 13 of the heat sink 12 is greater than the area of the opening 7 in the arc-shaped roof 4 of the enclosure 2, such that the arc-shaped base surface 13 covers the opening 7 for enabling air-tight enclosure 2.

The area of the arc-shaped roof 4 of the enclosure 2 is equal to the area of the base surface 13 of the heat sink 12. Such an embodiment offers the advantage of an improved aesthetical appearance and compact design, while ensuring that the opening 7 in the arc-shaped roof 4 is covered by the base surface 13 of the heat sink 12 at all times.

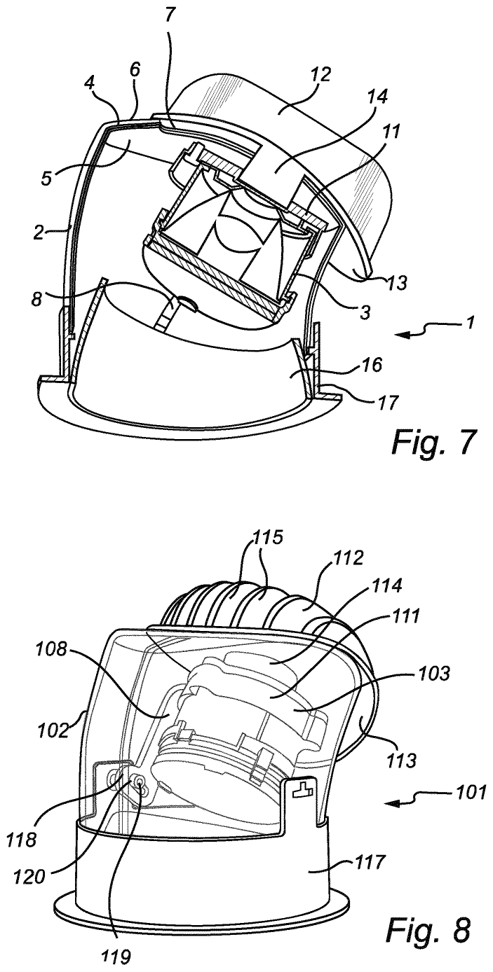

When the LED optics 3 is rotated to adjust the angle, the connected heat sink 12 also rotates along with it, as may be seen in FIGS. 4, 6 and 7. The base surface 13 of the heat sink 12 maintains a sliding contact with the arc-shaped roof 4 of the enclosure 2 since both the curvatures are matching. The opening 7 in the arc-shaped roof 4 of the enclosure 2 is the only opening in the enclosure 2. The opening 7 gets completely covered by the base surface 13 of the heat sink 12 resting on the outer surface 6 of the arc-shaped roof 4 of the enclosure 2 in all the tilted states. This ensures an air-tight and dustproof downlight fixture 1.

The heat sink 12 has an arc-shaped base surface 13 with the selected rotation axis X as the center. The heat sink 12 is designed to rest on the arc-shaped roof 4 of the enclosure 2. The connector shaft 14 may be extruded and is arranged at the center of the base surface 13. The connector shaft 14 and the heat sink 12 may be extruded as a single piece.

The connector shaft 14 passes through the opening 7 in the arc-shaped roof 4 of the enclosure 2 and is connected to the LED optics 3 inside the enclosure 2. As mentioned above, the base surface 13 of the heat sink 12 resting on the arc-shaped roof 4 of the enclosure 2 covers the opening in all tilting positions. The LED optics 3 is completely within the enclosure 2 and only the heat sink 12 is external to the enclosure 2. This ensures protection of LED optics 3 from external dust and debris and provides improved and unobstructed optical performance. The external heat sink 12 connected through the connector shaft 14 ensures good heat dissipation.

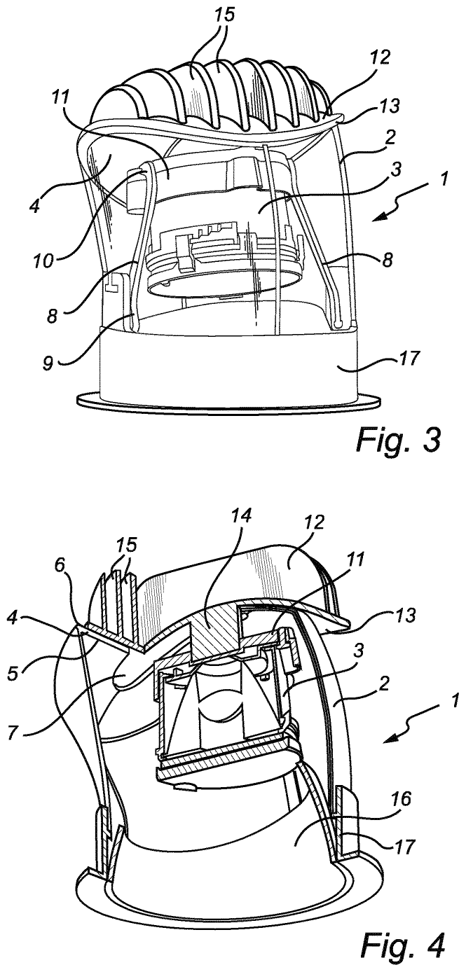

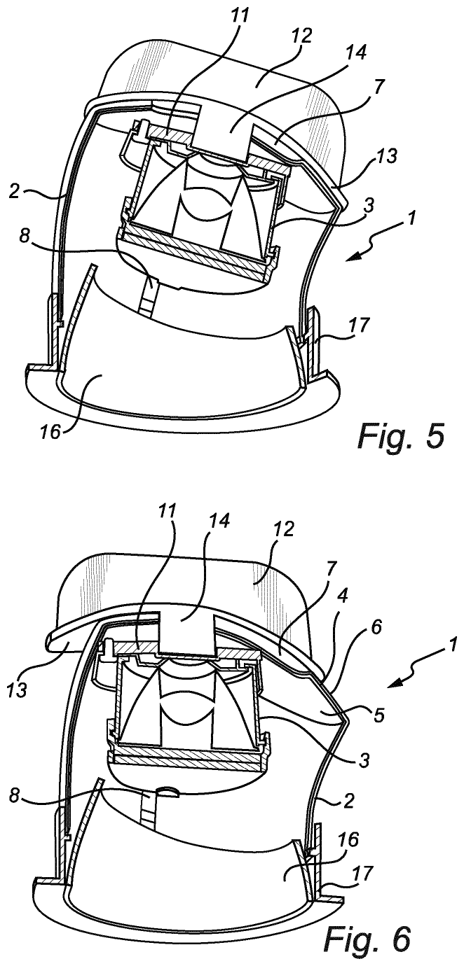

The heat sink 12 can be aligned with the enclosure 2 to get a compact form while installing the downlight fixture 1 (FIGS. 1, 3 and 5). This ensures a simple installation from below the ceiling. The user can tilt and/or rotate the LED optics 3 thus adjusting the angle of lighting by accessing from below the trim. As already have been mentioned, the base surface 13 of the heat sink 12 covers the opening 7 in the arc-shaped roof 4 of the enclosure 2 to ensure a sealed housing from 0-degree to maximum tilt and in all the intermediate tilt positions.

In order to further improve heat dissipation, the heat sink 12 comprises a plurality of baffles 15 arranged on the surface being opposite to the base surface 13.

In the embodiment shown in FIGS. 1-7, the fixture 1 further comprise a reflector 16 arranged downstream from the LED optics 3. The reflector 16 may be in the form of a detachable part connected to the bottom of the enclosure 2. The bottom of the enclosure 2 coincide with the light exit window.

The downlight fixture 1 further comprises a mount ring 17 arranged downstream from the LED optics 3. Such an embodiment offers the advantage of an improved aesthetical appearance and more secure attachment of the downlight fixture 1 to the ceiling.

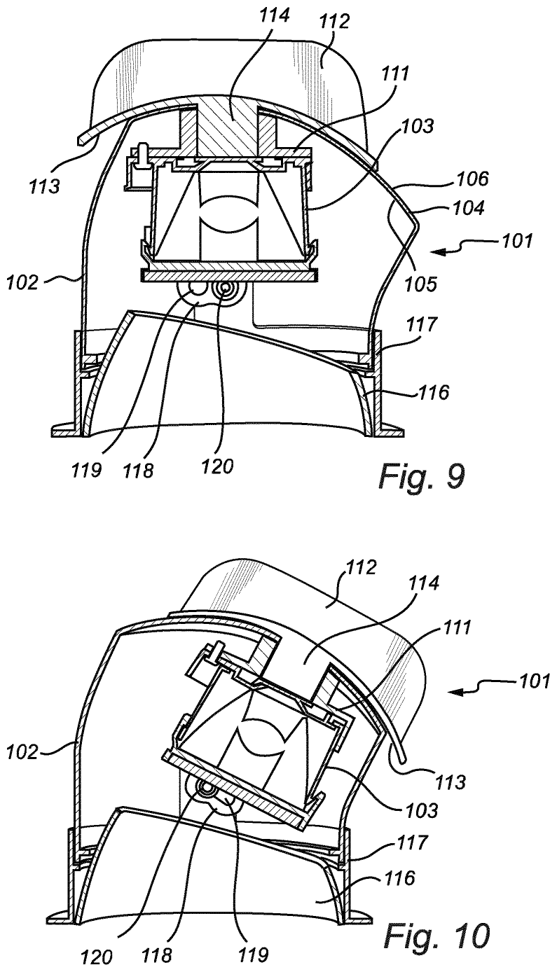

In the embodiment shown in FIGS. 8-10, the pivot arm 108 comprise a tilt-locking element 118 in the form of a slot 119 and a fastening element 120, e.g. a screw, extending through the slot 119. When the fastening element 120 is fixated inside the slot 119, tilting of the LED optics 113 will be prevented. The tilt-locking element 118 should be accessible from the outside of the enclosure 102 in order to be readily operatable by the user.

The person skilled in the art realizes that the present invention by no means is limited to the preferred embodiments described above. On the contrary, many modifications and variations are possible within the scope of the appended claims. For example, the features of the different embodiments described herein may be combined in different ways.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An adjustable downlight fixture, comprising:
an enclosure for accommodating LED optics, said enclosure (having an arc-shaped roof having an inner surface and an outer surface, said arc-shaped roof further comprising an opening;
at least one pivot arm for connecting said LED optics to said enclosure, said pivot arm having a first and a second end, said first end being pivotally connected to said enclosure at a rotation axis and said second end being arranged to be connected to said LED optics, wherein said LED optics is arranged to rotate relative the rotation axis X to achieve the angle adjustment; and
a heat sink having an arc-shaped base surface arranged adjacent to said outer surface of said arc-shaped roof of said enclosure, wherein the curvature of said base surface is substantially the same as the curvature of said arc-shaped roof;
wherein said heat sink is arranged to be connected to said LED optics by a connector shaft extending through said opening in said arc-shaped roof; and
wherein the area of said base surface of said heat sink is greater than the area of said opening such that said arc-shaped base surface covers said opening for enabling air-tight enclosure.

2. The adjustable downlight fixture according to claim 1, wherein said enclosure has a bent cylindrical shape.

3. The adjustable downlight fixture according to claim 1, wherein said fixture further comprises a reflector arranged downstream from said LED optics.

4. The adjustable downlight fixture according to claim 1, wherein said at least one pivot arm comprises a tilt-locking element.

5. The adjustable downlight fixture according to claim 1, wherein said downlight fixture comprises two pivot arms.

6. The adjustable downlight fixture according to claim 1, wherein said opening is substantially circular.

7. The adjustable downlight fixture according to claim 1, wherein said LED optics comprises a mount plate arranged to be connected to said at least one pivot arm.

8. The adjustable downlight fixture according to claim 1, wherein said connector shaft and said heat sink are extruded as a single piece.

9. The adjustable downlight fixture according to claim 1, wherein said downlight fixture further comprises a mount ring arranged downstream from said LED optics.

10. The adjustable downlight fixture according to claim 1, wherein said LED optics comprises at least one LED light source.

11. The adjustable downlight fixture according to claim 1, wherein said heat sink comprises a plurality of baffles arranged on the surface being opposite to said base surface.

12. The adjustable downlight fixture according to claim 1, wherein the ratio between the area of said opening and the area of said roof is from 0.01 to 0.5.

13. The adjustable downlight fixture according to claim 1, wherein the area of said roof of said enclosure is equal to the area of said base surface of said heat sink.

14. The adjustable downlight fixture according to claim 1, wherein said heat sink comprises thermally conductive material.

15. The adjustable downlight fixture according to claim 1, wherein said LED optics comprises at least one lens.
